(19) United States
(12) Patent Application Publication
(10) Pub. No.: US 2003/0177063 A1
(43) Pub. Date: Sep. 18, 2003

(54) Custom data ADS

(76) Inventors: Kevin G. Currans, Philomath, OR (US); Rajeev K. Pandey, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/096,265

(22) Filed: Mar. 12, 2002

(51) Int. Cl. G06F 17/60

(52) U.S. Cl. 705/14

(57) ABSTRACT

Aspects of the present invention provide methods, a computer system, a computer medium and an article of manufacture for generating personalized advertising to accompany information to be sent to a user. In one embodiment, the method includes the steps of maintaining, in memory, a plurality of user profiles and a plurality of images associated with each user profile and selecting an image associated with the user. Next, the image is inserted into advertising to provide personalized advertising.

### BACKGROUND OF THE INVENTION

The present invention relates to advertising and more particularly, to providing particularized advertising relative to users receiving information in printed or electronic form.

The Internet has provided many opportunities for businesses to publish information that is available to a wide range of users. Access to the information is available twenty-four hours a day, making it more convenient for users to utilize the Internet information at times that are convenient for them individually. The easy access to the Internet information increases the number of users that may access the information, thus increasing the exposure of users to advertising information associated with the Internet information. Advertisers are becoming more aggressive in pursing advertising opportunities.

Advertisers have taken advantage of the increased exposure by providing banner ads and ad inserts that are automatically displayed on the user's screen when the Internet information is accessed. However, such advertising has not been associated individually with each user. If, when information is sent to a user, advertising were to be adapted to associate the advertising with the particular user, such advertising would have more impact on the user, possibly leading to more impact on the user of the advertising and a greater likelihood of the user's reading the advertising and possibly utilizing the advertised service and/or purchasing the advertised product.

Thus, there is a need for methods, a computer system, a computer medium and an article of manufacture for automatically providing personalized advertising for a user.

### SUMMARY OF THE INVENTION

Aspects of the present invention provide methods, a computer system, a computer medium and an article of manufacture for automatically generating personalized advertising. In one embodiment, the method includes the steps of maintaining, in memory, a plurality of user profiles and a plurality of images associated with each user profile and selecting an image associated with the user and inserting the image into advertising to provide personalized advertising.

### BRIEF DESCRIPTION OF THE DRAWINGS

FIG. 1 is a flow chart showing one embodiment of a method for automatically combining personalized advertising with information to be sent to a user in accordance with the present invention.

FIG. 2 is a flow chart of another embodiment of steps for a method for generating personalized advertising to accompany information to be sent to a user in accordance with the present invention.

FIG. 3 is a block diagram of a computer system with a computer medium having computer-executable instructions for automatically combining personalized advertising with information for a user in accordance with the present invention.

FIG. 4 is a block diagram of one embodiment of an article of manufacture having a computer medium with computer-executable code for implementing steps in accordance with a method of the present invention.

FIG. 5 is a block diagram of one embodiment of a computer-readable medium having computer-executable instructions, in accordance with the present invention, for automatically combining personalized advertising with information that is downloaded to a user.

### DETAILED DESCRIPTION OF THE PREFERRED EMBODIMENT

The present invention personalizes advertising for information to be sent to a user to increase the effectiveness of the advertising on the individual. A personalized image may be inserted into electronic or printed information to be sent to a user. By inserting into advertising an image of the user, a related person, someone known socially, a professional associate, an individual in the community and/or an image of a geographically relevant building or landmark or the like, the present invention makes the received information more meaningful to the user and increases the likelihood that the user will react favorably to the advertising.

Digital imagery for the ads may be accomplished via masking, as is known in the art. In an example of how the imagery for the ads may be accomplished, the following set of steps may be taken. A picture of the user in a first environment may be designated “layer 0”. The head or head and shoulders may be masked and copied as “mask 0” so that they may be placed in “layer 1” as a reference. That is, layer 1 contains the “head shot” of the user. “Layer 2” may be an ad showing a second person in a second environment. The head or head and shoulders of the second person may be removed and replaced with the “head shot” of the user, thus showing the user in the second environment. In this manner, the user may be place in various environments that are suitable for ads, and the person viewing the ads may be more impacted by the ads if he recognizes himself or someone he knows in the ads.

Thus, there are two types of users in exemplary embodiments of the present invention 1) consumers of the advertising and 2) the advertising models. The consumers of the advertising are the individuals receiving the advertising. Thus consumers of the advertising may the advertising models themselves or individuals who may recognize the advertising model in the advertising they receive. The advertising model is the user whose image is inserted into the advertising. Thus, both types of consumers of the advertising are included as users in the implementation of the present invention, which is described with greater particularity below.

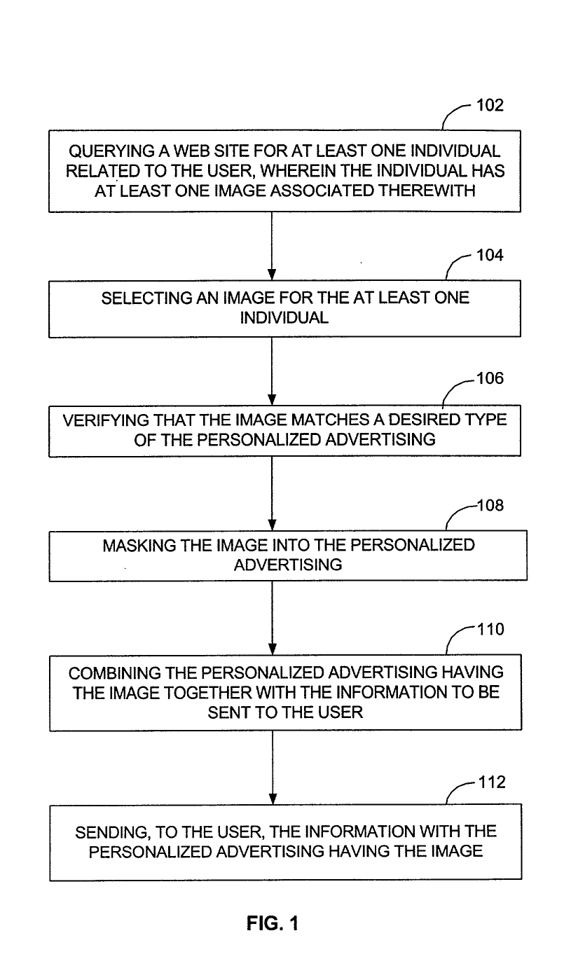

FIG. 1 is a flow chart showing one embodiment of a method for automatically combining personalized advertising with information to be sent to a user, in accordance with the present invention. First, a web site is queried (102) for at least one individual related to the user, wherein the individual has at least one image associated therewith. Then, an image is selected (104) for the at least one individual, such as the user, an individual related to the user (i.e., a family member), a social acquaintance, or a geographically significant image. The image is verified (106) as being of a desired type suitable or matching for the particular type of the personalized advertising, and the image is then masked 108 into the personalized advertising. The personalized advertising having the image is then combined (110) with the information to be sent to the user, and the information with the personalized advertising having the image is sent (112) to the user.

If desired, the personalized advertising may be selected from a file of subject matter gathered from a customer profile for the user. Also, the at least one individual may be associated with the user via a community association, a professional association, or the like. In addition, a file of subject matter may be gathered from a customer profile for the user and the user's image may be inserted into the personalized advertising. In one embodiment, the personalized advertising may be selected from a file of subject matter gathered from a customer profile for the user, the user's image may be inserted into the personalized advertising, and a community's image associated with the user may be incorporated into the personalized advertising.

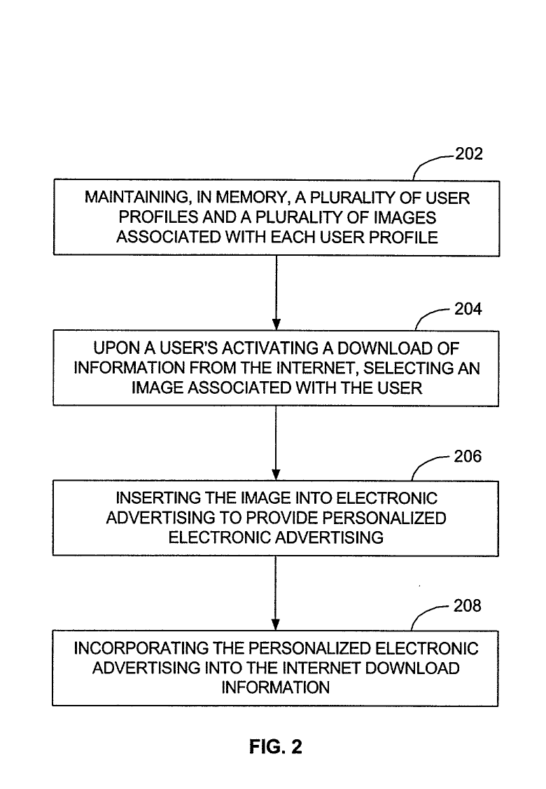

FIG. 2 is a flow chart of another embodiment of steps for a method for generating personalized advertising to accompany information to be sent to a user in accordance with the present invention. A plurality of user profiles and a plurality of images associated with each user profile are maintained (202) in memory. Upon a user's activating a download of information from the Internet, an image associated with the user is selected (204). Next, the image is inserted (206) into the electronic advertising to provide personalized electronic advertising, and then the personalized electronic advertising is incorporated (208) into the Internet download information. As above, the image associated with the user may be related to the user geographically, family and/or socially, may be an image of the user himself/herself, and/or may be associated with the user's community or the user's profession.

Where desired, a customer profile of the user may be developed, and the image may be selected from a set of images in the customer profile for the user. The customer profile may include the user's image, which may be inserted into the electronic advertising to personalize the advertising specifically for the user. In addition to inserting the user's image into the electronic advertising, a community's image associated with the user may also be incorporated for further personalization.

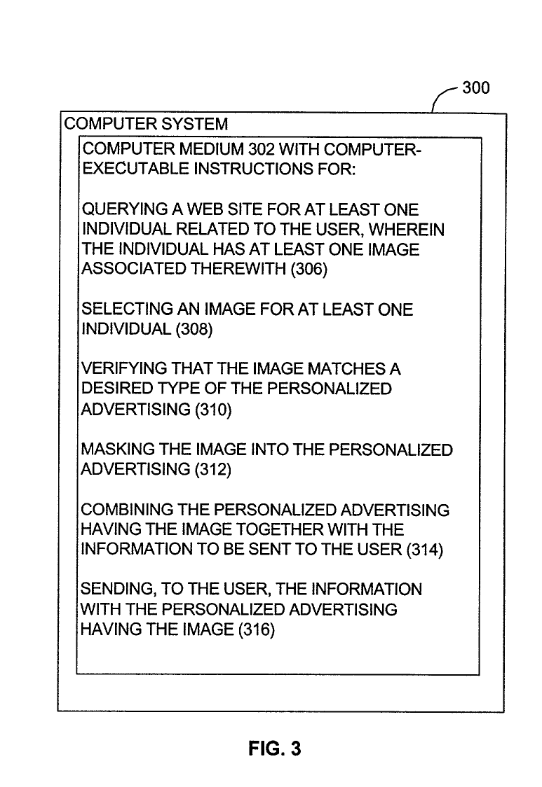

FIG. 3 is a block diagram of a computer system (300) with a computer medium (302) having computer-executable instructions (304) for automatically combining personalized advertising with information to be sent to a user in accordance with the present invention. In the embodiment of FIG. 3, the computer-executable instructions (304) include querying (306) a web site for at least one individual related to the user, wherein the individual has at least one image associated therewith and selecting (308) an image for the at least one individual. The image may, for example, be an image of the user, of an individual that is related by family to the user, of a social acquaintance, and/or of a landmark or other geographically significant structure. The image may also be of an individual who belongs to a community association or a professional association to which the user belongs. Next, the image is verified (310) to be of a desired type that matches the personalized advertising. The image is masked (312) into the personalized advertising, and the information to be sent to the user is combined (314) with the personalized advertising. The information with the personalized advertising having the image is then sent (316) to the user.

Where desired, a file of subject matter may be gathered from a customer profile for the user and may be inserted, with a community's image if desired, into the personalized advertising.

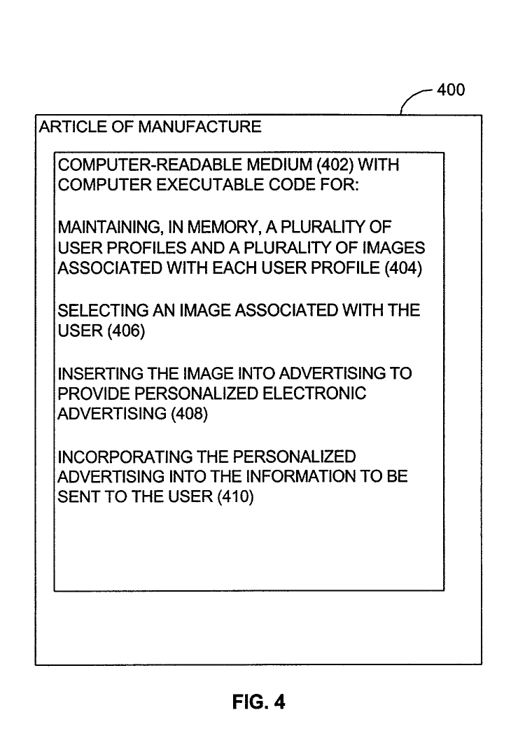

As shown in FIG. 4, the present invention may be embodied in an article of manufacture (400) that has a computer-readable medium (402) having computer-executable code for generating personalized advertising to accompany the information to be sent to a user in accordance with the invention. For example, an article of manufacture may be a computer, a computing system, a personal digital assistant such as a hand-held computer, or any suitable system for accessing the Internet. The computer-executable code includes code (404) for maintaining, in memory, a plurality of user profiles and a plurality of images associated with each user profile. Also, the computer-executable code includes code (406) for selecting an image associated with the user. Such code also includes code (408) for inserting the image into advertising to provide personalized advertising. The computer-executable code further includes code (410) for incorporating the personalized advertising into the information to be sent to the user. In the embodiment shown in FIG. 4, images may be selected and inserted into electronic advertising or printed advertising as described more fully above.

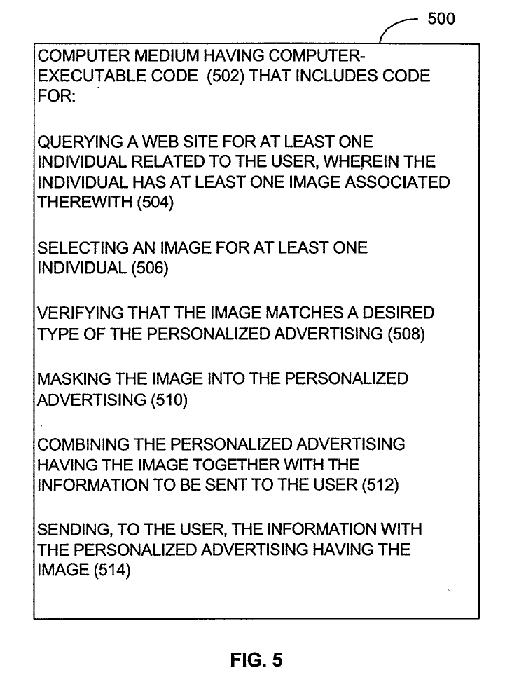

FIG. 5 is a block diagram of one embodiment of a computer-readable medium (500) having computer-executable code (502), in accordance with the present invention, for combining for automatically combining personalized advertising with information to be sent to a user. For example, the computer-readable medium may include a CD, a digital tape, or the like. The computer-executable code provides for querying (504) a web site for at least one individual related to the user, wherein the individual has at least one image associated with it. Code (506) also provides for selecting an image for the at least one individual and verifying that the image matches a desired type of the personalized advertising. In addition, the code (508) provides for masking the image into the personalized advertising and combining the personalized advertising with the information to be sent to the user. The computer-executable code includes code for sending (510), to the user, the information with the personalized advertising having the image. Images may be selected as described in further detail above.

Thus, methods, a computer system, a computer medium and an article of manufacture have been described according to the present invention. Many modifications and variations may be made to the techniques and structures described and illustrated herein without departing from the spirit and scope of the invention. Accordingly, it should be understood that the methods, computer system, computer medium and article of manufacture described herein are illustrative only and are not limiting upon the scope of the invention.

What is claimed is:

1. A method for combining personalized advertising with information to be sent to a user, comprising the steps of:
querying a web site for at least one individual related to the user, wherein the individual has at least one image associated therewith;
selecting an image for the at least one individual;
verifying that the image matches a desired type of the personalized advertising;
masking the image into the personalized advertising;
combining the personalized advertising having the image together with the information to be sent to the user; and
sending, to the user, the information with the personalized advertising having the image.

2. The method of claim 1 wherein the information to be sent to the user is one of: electronic information and printed information.

3. The method of claim 1 wherein the user is one of: a consumer of the advertising and is different from the at least one individual whose image is in the advertising and a consumer of the advertising and is the individual whose image is in the advertising.

4. The method of claim 1 wherein the at least one individual is related via at least one of: geographically, family and socially.

5. The method of claim 1 wherein the at least one individual is the user.

6. The method of claim 1 wherein the at least one individual is associated with the user via one of: a community association and a professional association.

7. The method of claim 1 wherein the personalized advertising is selected from a file of subject matter gathered from a customer profile for the user.

8. The method of claim 1 wherein the personalized advertising is selected from a file of subject matter gathered from a customer profile for the user and the user's image is inserted into the personalized advertising.

9. The method of claim 1 wherein the personalized advertising is selected from a file of subject matter gathered from a customer profile for the user, the user's image is inserted into the personalized advertising, and a community's image associated with the user is incorporated into the personalized advertising.

10. A method for generating personalized electronic advertising to accompany Internet download information, comprising the steps of:
maintaining, in memory, a plurality of user profiles and a plurality of images associated with each user profile;
upon a user's activating a download of information from the Internet, selecting an image associated with the user;
inserting the image into electronic advertising to provide personalized electronic advertising; and
incorporating the personalized electronic advertising into the Internet download information.

11. The method of claim 10 wherein the user is one of: a consumer of the advertising and is different from the at least one individual whose image is in the advertising and a consumer of the advertising and is the individual whose image is in the advertising.

12. The method of claim 10 wherein the image associated with the user is related to the user via at least one of: geographically, family and socially.

13. The method of claim 10 wherein the image associated with the user is an image of the user.

14. The method of claim 10 wherein the image associated with the user is associated with the user via one of: a community association and a professional association.

15. The method of claim 10 wherein the image is selected from a set of images in a customer profile for the user.

16. The method of claim 10 wherein the image is selected from a set of images in a customer profile for the user and the image utilized is the user's image, which is inserted into the electronic advertising to provide personalized electronic advertising.

17. The method of claim 10 wherein the image is selected from a set of images in a customer profile for the user, the image utilized is the user's image, which is inserted into the electronic advertising, and a community's image associated with the user is incorporated into the electronic advertising to provide personalized electronic advertising.

18. A computer system with a computer medium having computer-executable instructions for automatically combining personalized advertising with information to be sent to a user, the computer-executable instructions including the steps of:
querying a web site for at least one individual related to the user, wherein the individual has at least one image associated therewith;
selecting an image for the at least one individual;
verifying that the image matches a desired type of the personalized advertising;
masking the image into the personalized advertising;
combining the personalized advertising having the image together with the information to be sent to the user; and
sending, to the user, the information with the personalized advertising having the image.

19. The computer system of claim 18 wherein the user is one of: a consumer of the advertising and is different from the at least one individual whose image is in the advertising and a consumer of the advertising and is the individual whose image is in the advertising.

20. The computer system of claim 18 wherein the information to be sent to the user is one of: electronic information and printed information.

21. The computer system of claim 18 wherein the at least one individual is related via at least one of: geographically, family and socially.

22. The computer system of claim 18 wherein the at least one individual is the user.

23. The computer system of claim 18 wherein the at least one individual is associated with the user via one of: a community association and a professional association.

24. The computer system of claim 18 wherein the personalized advertising is selected from a file of subject matter gathered from a customer profile for the user.

25. The computer system of claim 18 wherein the personalized advertising is selected from a file of subject matter gathered from a customer profile for the user and the user's image is inserted into the personalized advertising.

26. The computer system of claim 18 wherein the personalized advertising is selected from a file of subject matter gathered from a customer profile for the user, the user's image is inserted into the personalized advertising, and a community's image associated with the user is incorporated into the personalized advertising.

27. An article of manufacture comprising:
a computer-readable medium having computer-executable code for generating personalized advertising to accompany information to be sent to a user, wherein the computer-executable code includes:
computer-executable code for maintaining, in memory, a plurality of user profiles and a plurality of images associated with each user profile;
computer-executable code for selecting an image associated with the user;
computer-executable code for inserting the image into advertising to provide personalized advertising; and
computer-executable code for incorporating the personalized advertising into the information to be sent to the user.

28. The article of manufacturing of claim 27 wherein the user is one of: a consumer of the advertising and is different from the at least one individual whose image is in the advertising and a consumer of the advertising and is the individual whose image is in the advertising.

29. The article of manufacture of claim 27 wherein the information to be sent to the user is one of: electronic information and printed information.

30. The article of manufacture of claim 27 wherein the image associated with the user is related to the user via at least one of: geographically, family and socially.

31. The article of manufacture of claim 27 wherein the image associated with the user is an image of the user.

32. The article of manufacture of claim 27 wherein the image associated with the user is associated with the user via one of: a community association and a professional association.

33. The article of manufacture of claim 27 wherein the image is selected from a set of images in a customer profile for the user.

34. The article of manufacture of claim 27 wherein the image is selected from a set of images in a customer profile for the user and the image utilized is the user's image, which is inserted into the advertising to provide personalized advertising.

35. The article of manufacture of claim 27 wherein the image is selected from a set of images in a customer profile for the user, the image utilized is the user's image, which is inserted into the advertising, and a community's image associated with the user is incorporated into the advertising to provide personalized advertising.

36. A computer-readable medium having computer-executable code for automatically combining personalized advertising with information to be sent to a user, comprising the steps of:
computer-executable code for querying a web site for at least one individual related to the user, wherein the individual has at least one image associated therewith;
computer-executable code for selecting an image for the at least one individual and verifying that the image matches a desired type of the personalized advertising;
computer-executable code for masking the image into the personalized advertising and combining the personalized advertising with the information to be sent to the user; and
computer-executable code for sending, to the user, the information with the personalized advertising having the image.

37. The computer-readable medium of claim 36 wherein the user is one of: a consumer of the advertising and is different from the at least one individual whose image is in the advertising and a consumer of the advertising and is the individual whose image is in the advertising.

38. The computer-readable medium of claim 36 wherein the information to be sent to the user is one of: electronic information and printed information.

39. The computer-readable medium of claim 36 wherein the at least one individual is related via at least one of: geographically, family and socially.

40. The computer-readable medium of claim 36 wherein the at least one individual is the user.
